(19) United States
(12) Patent Application Publication
(10) Pub. No.: US 2006/0091628 A1
(43) Pub. Date: May 4, 2006

(54) Article carrier for ski equipment

(76) Inventor: Carol Ann Cheslak, Charlotte, NC (US)

Correspondence Address: Schwartz Law Firm, P.C.;SouthPark Towers, Suite 530, 6100 Fairview Road, Charlotte, NC, 28210, US

(21) Appl. No.: 10/977,586

(22) Filed: Oct. 29, 2004

(51) Int. Cl. B62B 1/00

(52) U.S. Cl. 280/47.27

(57) ABSTRACT

An article carrier has a frame assembly including a handle and a wheel axle. At least one wheel is rotatably mounted on the axle. A platform is attached to the frame assembly adjacent the wheel axle, and is adapted for supporting articles above a ground surface. A pivoted swing arm is attached to the frame assembly above the platform. The swing arm is movable between a stowed position and an in-use position. In the in-use position, the swing arm is adapted for holding articles positioned on the platform and extending vertically in a direction of the handle.

### TECHNICAL FIELD AND BACKGROUND OF THE INVENTION

This invention relates to an article carrier. The invention resembles a conventional, lightweight hand truck with features particularly suited for handling ski equipment, such as skis, poles, boots, and the like. The invention facilitates transport of ski equipment between a vehicle or rental facility and the ski slope.

Numerous products exist in the prior art for transporting ski equipment. Among these include vehicle roof racks and personal backpacks. Roof racks are especially useful for carrying skis and related equipment which might otherwise be difficult to fit inside the vehicle. Once the vehicle is parked, however, the equipment must be unloaded and physically transported from the vehicle to the slope. Carrying the ski equipment is difficult, tiresome, and generally awkward particularly for younger children and adults with arm loads of other items.

Backpacks, or winter packs, are commonly used for carrying ski equipment and other accessories, and typically have specially designed compartments and straps for holding boots, skis, safety gear, goggles, and the like. While these carriers offer added convenience and help reduce the overall awkwardness in trying to handle several loose items at once, the loaded pack can be quite heavy and difficult to carry for long distances.

The present invention addresses these and other problems common to the above-mentioned carriers of the prior art. The invention conveniently and securely holds multiple items of ski equipment and related accessories, and facilitates their transport over rough and snowy terrain while exerting relatively little physical energy.

### SUMMARY OF INVENTION

Therefore, it is an object of the invention to provide an article carrier which is especially applicable for holding and transporting ski equipment.

It is another object of the invention to provide an article carrier which includes features designed to support tall items of ski equipment, such as skis and poles.

It is another object of the invention to provide an article carrier which comprises a lightweight, fold-up aluminum frame.

It is another object of the invention to provide an article carrier which is convenient to maneuver.

It is another object of the invention to provide an article carrier which is collapsible for convenient storage in a vehicle trunk or other small area.

It is another object of the invention to provide an article carrier which has substantial weight capacity.

It is another object of the invention to provide a method for conveniently transporting articles of ski equipment.

These and other objects of the present invention are achieved in the preferred embodiments disclosed below by providing an article carrier. The article carrier has a frame assembly including a handle and a wheel axle. At least one wheel is rotatably mounted on the axle. A platform is attached to the frame assembly adjacent the wheel axle, and is adapted for supporting articles above a ground surface. A pivoted swing arm is attached to the frame assembly above the platform. The swing arm is movable between a stowed position and an in-use position. In the in-use position, the swing arm is adapted for holding articles positioned on the platform that extend vertically in a direction of the handle.

According to another preferred embodiment of the invention, the swing arm is attached to an elongated post adapted for sliding vertical movement relative to the frame assembly, thereby adjusting the vertical location of the swing arm relative to the platform.

According to another preferred embodiment of the invention, means are provided for setting the vertical location of the swing arm relative to the platform.

According to another preferred embodiment of the invention, the swing arm includes an article strap adapted for securing the articles in place when transported on the carrier.

According to another preferred embodiment of the invention, the swing arm has a generally wedge-shaped cross-section.

According to another preferred embodiment of the invention, the swing arm has a stop for limiting pivoting movement in the in-use position.

According to another preferred embodiment of the invention, the platform has at least one perforated support plate extending generally perpendicular to the frame assembly.

According to another preferred embodiment of the invention, the platform has separate heel and toe plates.

According to another preferred embodiment of the invention, the platform further includes opposing wire frame members interconnecting the heel and toe plates.

According to another preferred embodiment of the invention, the wire frame members define U-shaped legs adapted for supporting the carrier in a generally upright condition.

According to another preferred embodiment of the invention, the toe plate includes an elevated step and riser adapted for cooperating with the swing arm to hold tall articles on the carrier.

According to another preferred embodiment of the invention, an article strap is provided for securing articles in place on the platform during movement of the carrier.

According to another preferred embodiment of the invention, a wire wheel guard is attached to the platform and located adjacent the wheel to shield the wheel from articles carried on the platform.

According to another preferred embodiment of the invention, an angled step rod is attached to the frame assembly, and adapted to facilitate movement of the carrier over raised obstructions.

According to another preferred embodiment of the invention, the handle has a crossbar hand grip.

In another embodiment, the invention is a method for carrying ski equipment. The method includes the step of placing an article to be carried on a platform of a carrier. The carrier has a frame assembly including a handle and a wheel axle, and at least one wheel rotatably mounted on the axle. A free end of the article is then held against a vertically-adjustable swing arm located above the platform.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of the article carrier according to one preferred embodiment of the present invention, and showing the support platform in an open condition;

FIG. 2 is a perspective view of the article carrier with the support platform in a closed condition folded up against the frame;

FIG. 3 is an environmental view of the article carrier loaded with various articles of ski equipment;

FIG. 4 is an enlarged perspective view of the swing arm, and showing the locking tab in a released condition for sliding position adjustment of the swing arm along a length of the handle post;

FIG. 5 is an enlarged perspective view of the swing arm, and showing the locking tab in a locked condition to set the swing arm at a desired location along a length of the handle post;

FIG. 6 is an enlarged, fragmentary view of the article carrier showing the swing arm in the stowed position;

FIG. 7 is an enlarged, fragmentary view of the article carrier showing the swing arm in the in-use position;

FIG. 8 is a perspective view of the article carrier with the handle fully extended and the swing arm in a lowered in-use position;

FIG. 9 is a perspective view of the article carrier with the handle fully extended and the swing arm in a raised in-use position;

FIG. 10 is top view of the handle showing the swing arm in the stowed position extending substantially parallel to the crossbar of the hi-stacker;

FIG. 11 is top view of the handle showing the swing arm in the in-use position extending substantially 90-degrees to the crossbar of the hi-stacker, and further showing the locking tab in a released condition; and

FIG. 12 is a top view of the handle showing the swing arm in the in-use position extending substantially 90-degrees to the crossbar of the hi-stacker, and further showing the locking tab in a locked condition.

### DESCRIPTION OF THE PREFERRED EMBODIMENT AND BEST MODE

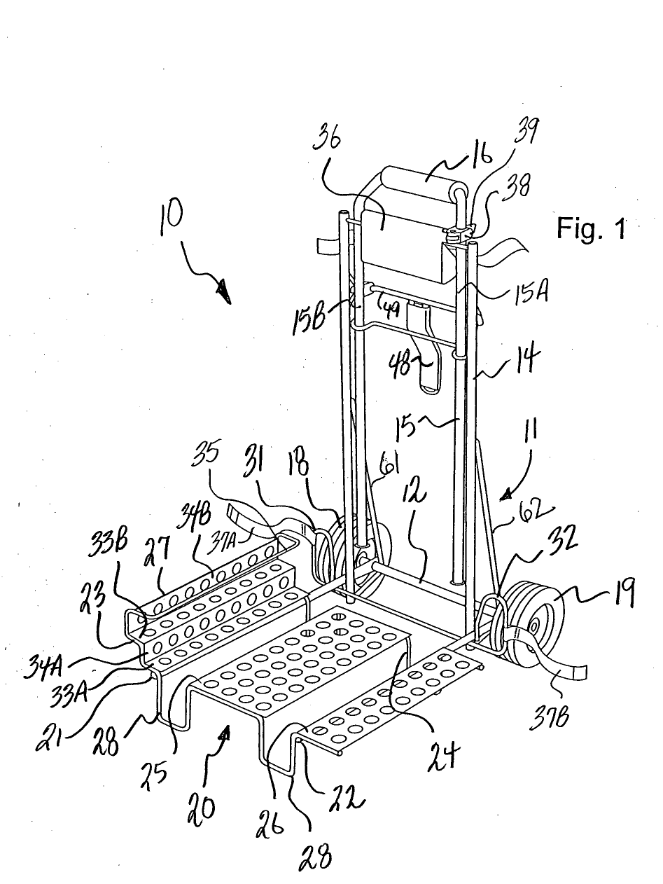

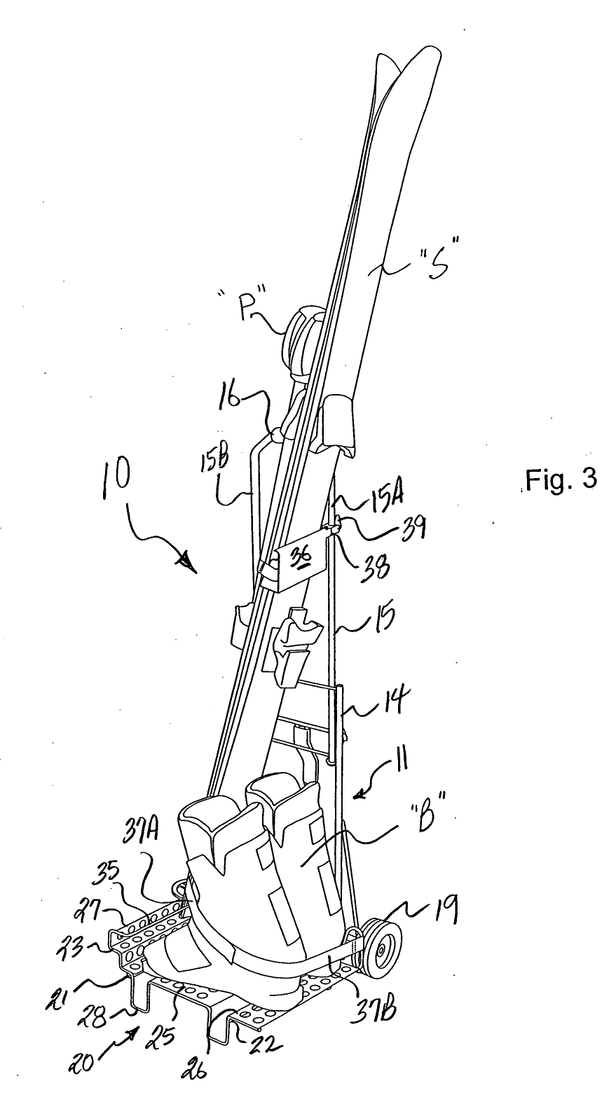

Referring now specifically to the drawings, an article carrier according to the present invention is illustrated in FIG. 1, and shown generally at reference numeral 10. The article carrier 10 is especially applicable for transporting ski equipment, such as boots “B”, skis “S”, and poles “P” (See FIG. 3). The carrier 10 is constructed of a lightweight, metal frame assembly 11 including an underslung wheel axle 12, fixed hi-stacker 14, collapsible handle 15, and a crossbar handgrip 16. Oversized wheels 18 and 19 are rotatably mounted at respective ends of the wheel axle 12. According to one embodiment, the wheels 18, 19 comprise 4-inch solid rubber tires each having a 2 to 3-inch wide tread sufficient to facilitate travel through snow.

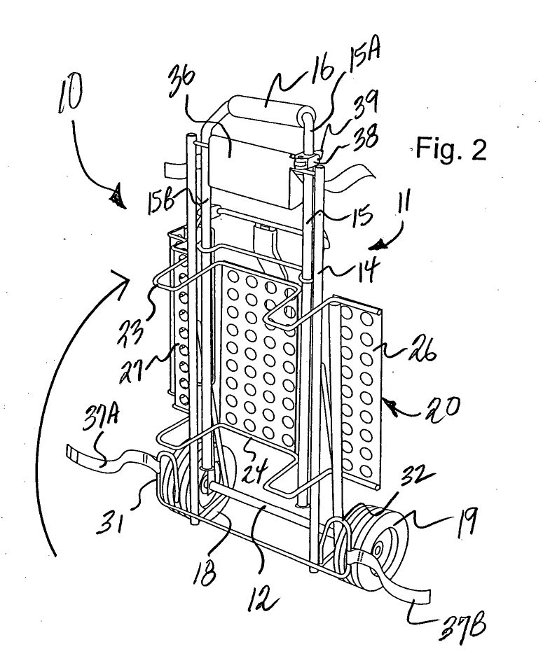

A fold-up metal platform 20 extends generally perpendicularly outward from the frame assembly 11 when arranged in an open, use position shown in FIG. 1. The platform 20 comprises laterally-spaced rigid support bars 21 and 22 attached to the frame assembly 11, and bent wire members 23 and 24 extending between and attached to the support bars 21, 22. The wire members 23, 24 support perforated metal plates 25, 26, and 27, and define respective U-shaped legs 28 designed to balance and level the platform 20 when loading articles to be carried. The support bars 21, 22 are pivotably attached to the wheel axle 12 of the frame assembly 11, and enable movement of the platform 20 between the opened position shown in FIG. 1 and a closed or stowed position shown in FIG. 2. Preferably, the platform 20 further includes wire wheel guards 31 and 32 attached to the support bars 21, 22 and operating to shield the wheels 18, 19 from items transported on the carrier 10.

The perforated support plates 25, 26, and 27 of the platform 20 are particularly suited for carrying ski boots “B”, as shown in FIG. 3. The center plate 25 is approximately 12″×6″ with perforations formed in over 50% of its entire surface area. The heel plate 26 is approximately 12″×4″ with perforations formed in over 50% of its entire surface area. Likewise, the toe plate 27 has perforations formed in over 50% of its entire surface area. The toe plate 27 defines steps 33A, 33B and risers 34A, 34B. The steps 33A, 33B and risers 34A, 34B cooperate with a pivoted swing arm 36, described below, to hold tall items of ski equipment, such as skis “S” and poles “P”. Preferably, an integrally-formed retaining bar 35 extends between the wire members 23 and 24, and is spaced from the second riser 34B to form a narrow slot for receiving and holding ends of the skis “S” and poles “P”. The items are further secured on the platform 20 by straps 37A and 37B attached to respective wheel guards 31 and 32, and having complementary mating hook and loop fasteners at respective free ends.

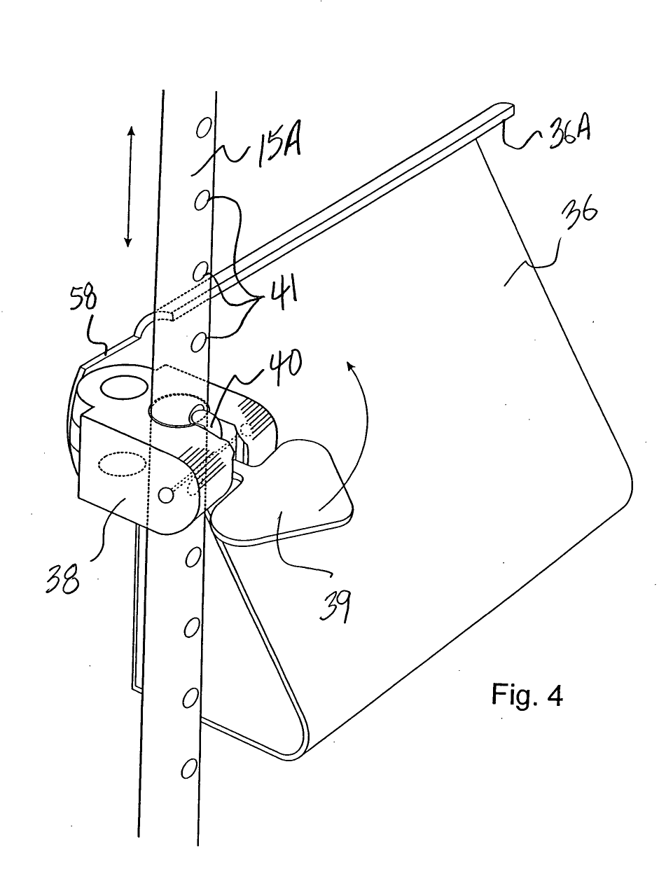

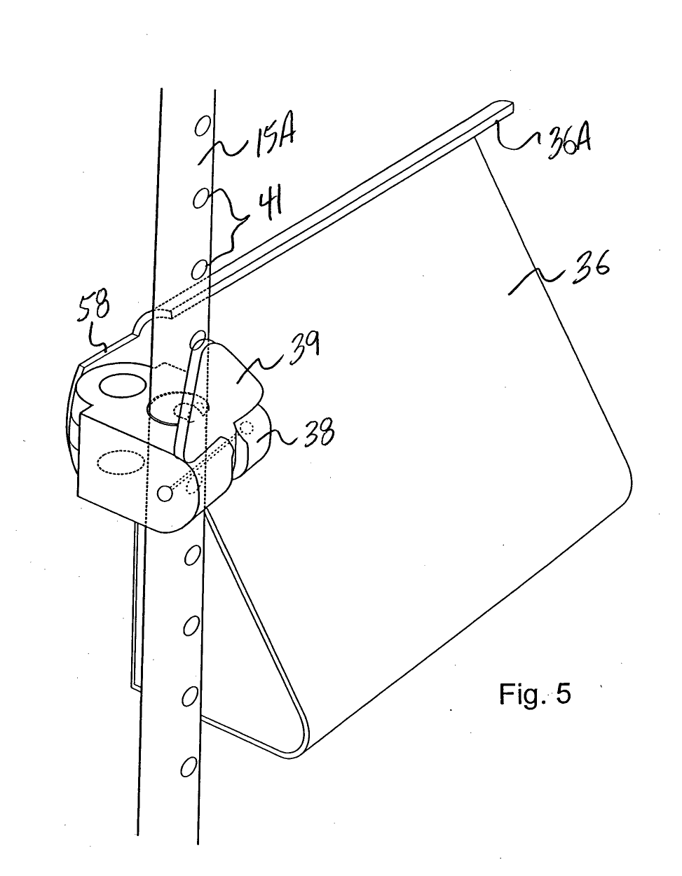

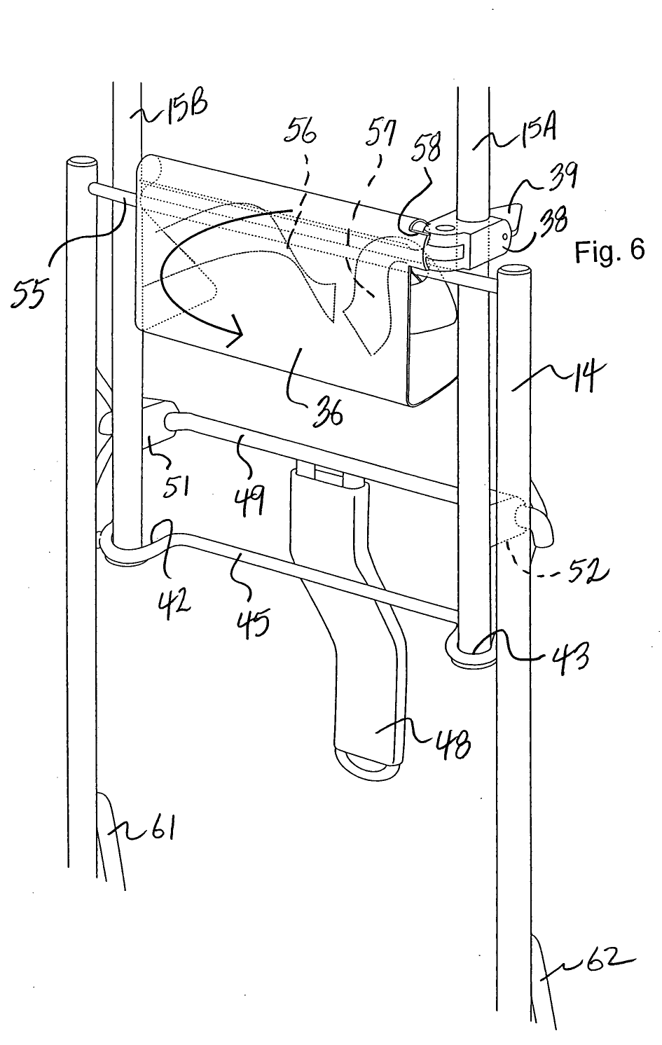

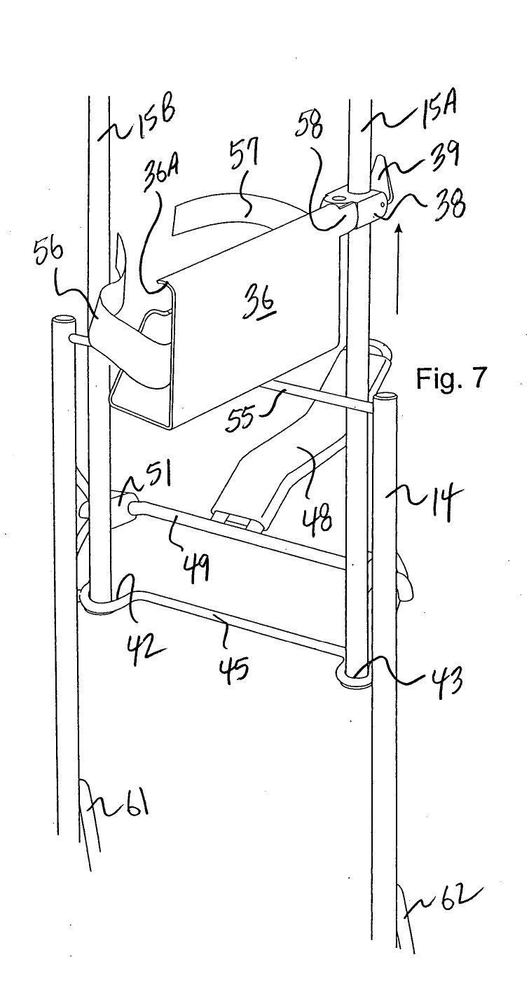

Referring to FIGS. 4-11, the swing arm 36 comprises a pivot connector 38 attached to an elongated vertical post 15A of the handle 15. The swing arm 36 is designed to slide up and down along a length of the handle post 15A in order to adjust its vertical spacing relative to the platform 20. The pivot connector 38 includes a locking tab 39, shown in FIGS. 4 and 5, with a finger 40 adapted to penetrate a selected opening 41 formed with the handle post 15A to set the position of the swing arm 36 relative to the handle 15. As best shown in FIGS. 6 and 7, the vertical posts 15A, 15B of the handle 15 are received within respective eyes 42 and 43 formed with a lower crossbar 45 attached to the hi-stacker 14. The eyes 42, 43 allow sliding movement of the handle 15 relative to the hi-stacker 14 in order to adjust the height of the swing arm 36 and handgrip 16.

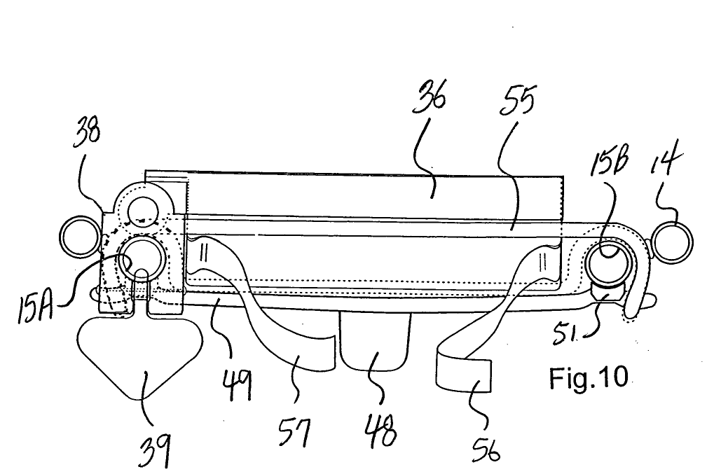

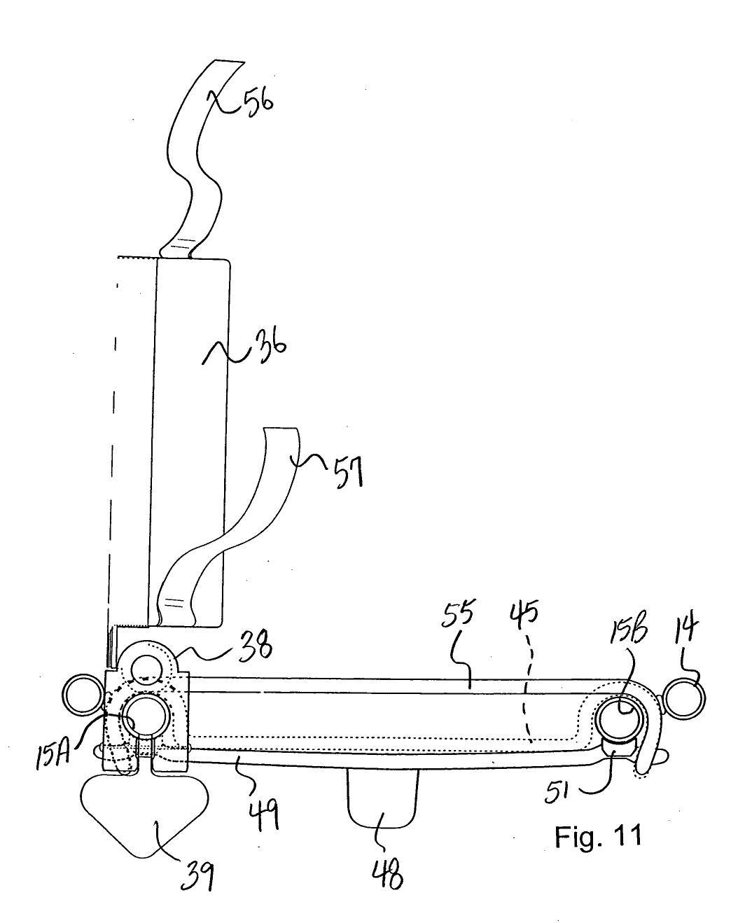

Sliding vertical movement of the handle 15 is controlled by manipulating a convenient locking lever 48. The locking lever 48 is fixed to a lateral brake rod 49, and is movable between a lowered locked position shown in FIG. 6 and a raised released position shown in FIG. 7. In the lowered position, resilient rubber brakes 51 and 52 (See FIGS. 10 and 11) attached to the brake rod 49 frictionally engage the handle posts 15A and 15B to restrict sliding movement. By lifting the locking lever 48 to the raised position, the brake rod 49 rotates the brakes 51, 52 out of engagement with the handle posts 15A, 15B to allow free sliding movement. FIG. 6 illustrates the swing arm 36 in a stowed position adjacent an upper crossbar 55 of the hi-stacker 14, and the handle 15 fully extended.

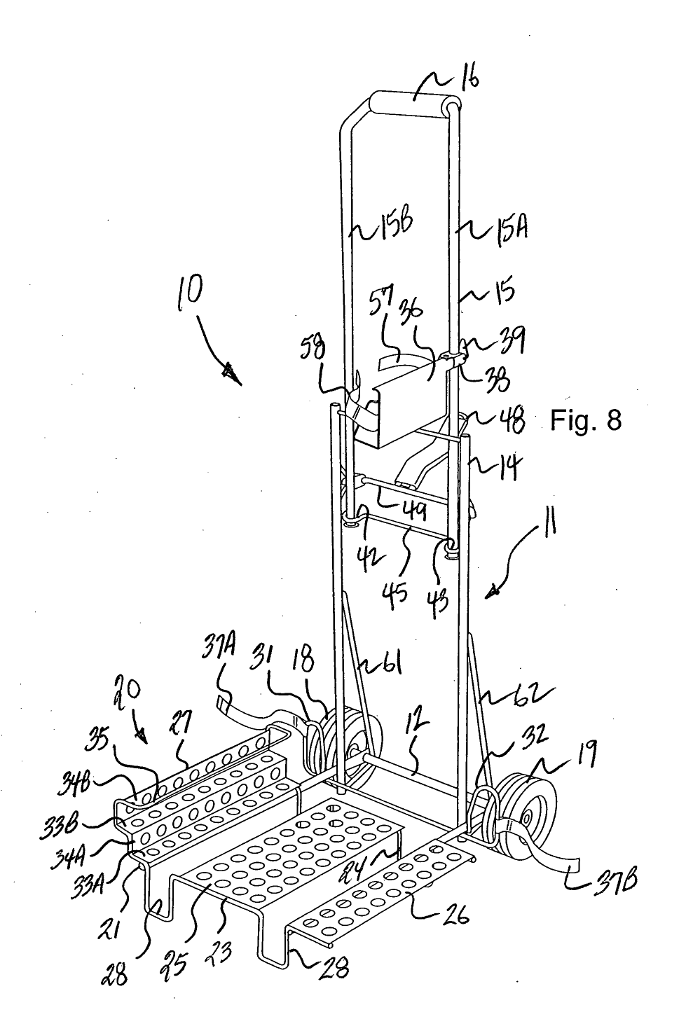

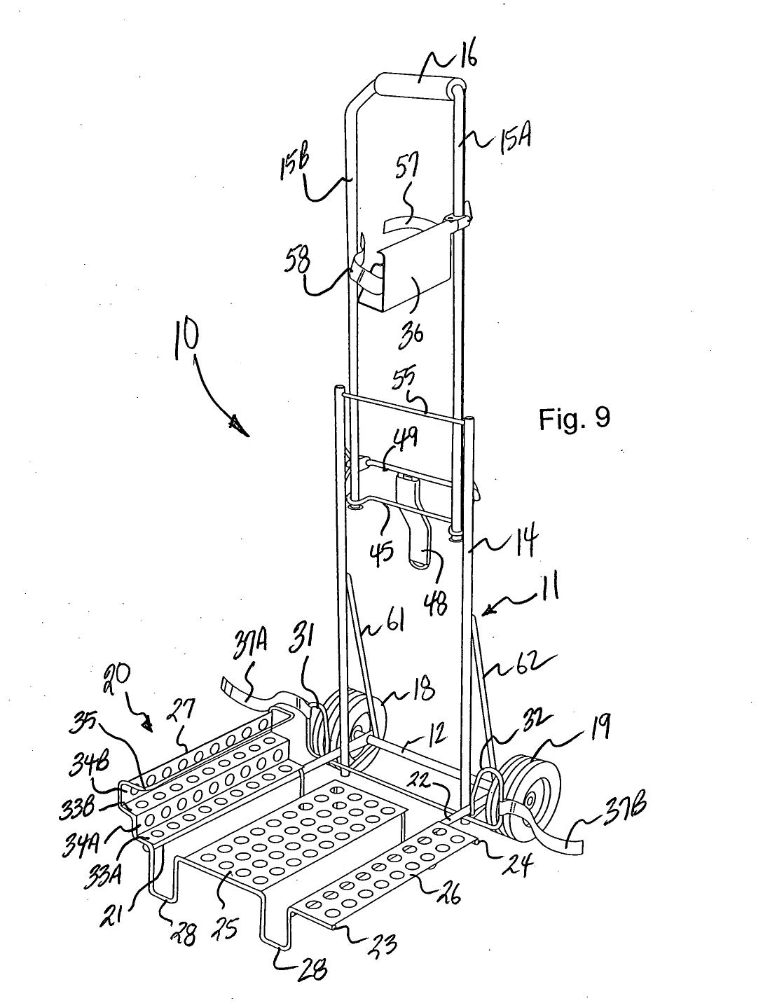

In order to secure skis, poles, and other tall items in the carrier 10, the swing arm 36 is pivoted from the stowed position to an in-use position, best shown in FIGS. 7 and 8, and then lifted vertically away from the upper crossbar 55 to a desired height above the platform 20, as best shown in FIG. 9. After setting the location of the swing arm 36 and handgrip 16, the locking lever 48 is moved from the raised position to the lowered position to re-engage the brakes 51 and 52 and prevent further sliding adjustment of the handle 15. The swing arm 36 is preferably constructed of a molded plastic or metal, and has a generally wedge-shaped profile with an inwardly-curved top lip 36A.

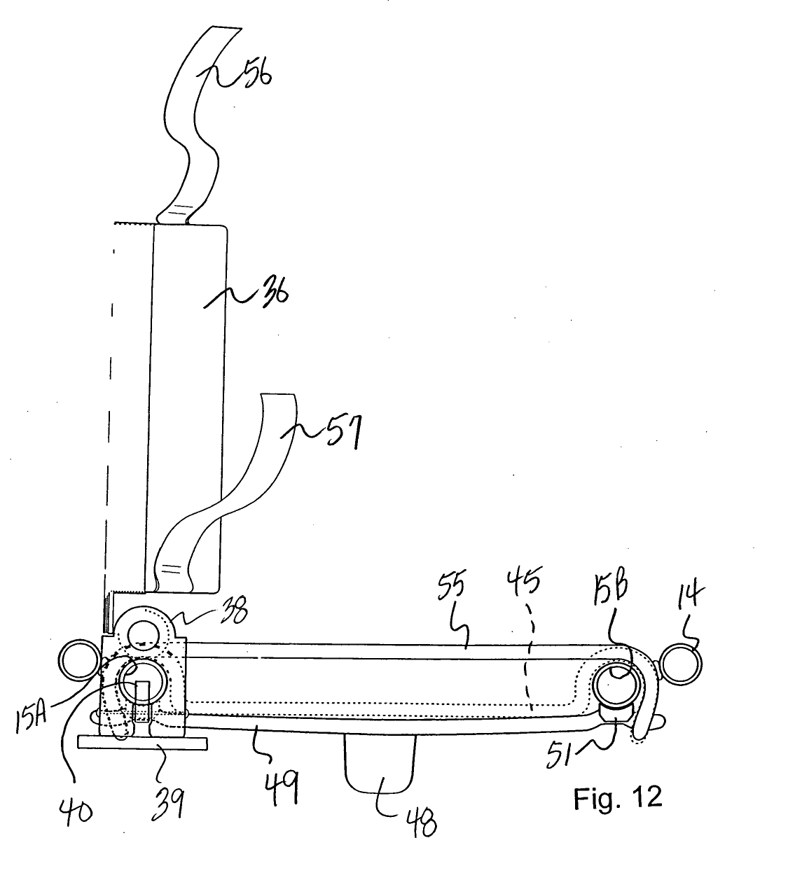

Referring to FIGS. 10, 11, and 12, when in the stowed position (FIG. 10), the swing arm 36 extends in a direction generally parallel to the upper crossbar 55 of the hi-stacker 14. When pivoted to the in-use position shown in FIGS. 11 and 12, the swing arm 36 extends generally 90-degrees to the crossbar 55 to support skis and poles carried on the platform 20. These items are further secured in the carrier 10 by straps 56 and 57 attached to the swing arm 36, and having complementary mating hook and loop fasteners. Pivoting movement of the swing arm 36 is limited by an integrally-formed stop 58 designed to engage the pivot connector 38. In the in-use position shown in FIG. 11 and with the locking tab 39 in a released condition, the swing arm 36 slides along the handle post 15A to a desired height relative to the platform 20. The position of the swing arm 36 is then set by lifting the tab 39 of the pivot connector 38 to insert the finger 40 into a selected opening 41 (See FIGS. 4 and 5). FIG. 12 shows the locking tab 39 of the pivot connector 38 in the locked condition. In addition, to facilitate transport of the loaded carrier 10 over curbs, steps, and other raised obstructions, angled step rods 61 and 62 are preferably attached to the frame assembly 11 as shown in FIG. 1.

An article carrier is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. An article carrier, comprising:
(a) a frame assembly including a handle and a wheel axle;
(b) at least one wheel rotatably mounted on said axle;
(c) a platform attached to said frame assembly adjacent said wheel axle, and adapted for supporting articles above a ground surface; and
(d) a pivoted swing arm attached to said frame assembly above said platform and movable between a stowed position and an in-use position, such that in the in-use position, said swing arm is adapted for holding articles positioned on said platform and extending vertically in a direction of said handle.

2. An article carrier according to claim 1, wherein said swing arm is slidably attached to an elongated post of said frame assembly and adapted for sliding vertical movement relative to said frame assembly, thereby adjusting the vertical location of said swing arm relative to said platform.

3. An article carrier according to claim 2, and comprising means for setting the vertical location of said swing arm relative to said platform.

4. An article carrier according to claim 1, wherein said swing arm comprises an article strap adapted for securing the articles in place when transported on said carrier.

5. An article carrier according to claim 1, wherein said swing arm has a generally wedge-shaped cross-section.

6. An article carrier according to claim 1, wherein said swing arm comprises a stop for limiting pivoting movement in the in-use position.

7. An article carrier according to claim 1, wherein said platform comprises at least one perforated support plate extending generally perpendicular to said frame assembly.

8. An article carrier according to claim 1, wherein said platform comprises separate heel and toe plates.

9. An article carrier according to claim 8, and wherein said platform further comprises opposing wire frame members interconnecting said heel and toe plates.

10. An article carrier according to claim 9, wherein said wire frame members define U-shaped legs adapted for supporting said carrier in a generally upright condition.

11. An article carrier according to claim 8, wherein said toe plate comprises an elevated step and riser adapted for cooperating with said swing arm to hold articles on said carrier.

12. An article carrier according to claim 1, and comprising an article strap adapted for securing articles in place on said platform during movement of said carrier.

13. An article carrier according to claim 1, and comprising a wire wheel guard attached to said platform and located adjacent said at least one wheel to shield said wheel from articles carried on said platform.

14. An article carrier according to claim 1, and comprising an angled step rod attached to said frame assembly, and adapted to facilitate movement of said carrier over raised obstructions.

15. An article carrier according to claim 1, wherein said handle comprises a crossbar hand grip.

16. An article carrier for ski equipment, comprising:
(a) a frame assembly including a handle and a wheel axle;
(b) at least one wheel rotatably mounted on said axle; and
(c) a platform attached to said frame assembly adjacent said wheel axle, and comprising at least one perforated support plate adapted for supporting articles above a ground surface.

17. An article carrier according to claim 16, wherein said platform comprises separate perforated heel and toe plates.

18. An article carrier according to claim 17, and wherein said platform comprises opposing wire frame members interconnecting said heel and toe plates.

19. An article carrier according to claim 18, wherein said wire frame members define U-shaped legs adapted for supporting said carrier in a generally upright condition.

20. A method for carrying ski equipment, comprising the steps of:
(a) placing an article to be carried on a platform of a carrier, the carrier comprising a frame assembly including a handle and a wheel axle, and at least one wheel rotatably mounted on the axle; and
(b) holding a free end of the article against a vertically-adjustable swing arm located above the platform.
